(19) United States
(12) Patent Application Publication
(10) Pub. No.: US 2004/0206003 A1
(43) Pub. Date: Oct. 21, 2004

(54) Window sash counterbalance and position locking system for a tilt-in window

(76) Inventors: John R. Kunz, Douglassville, PA (US); Keith Kannengieszer, Hatfield, PA (US)

Correspondence Address: LAMORTE & ASSOCIATES P.C., P.O. BOX 434, YARDLEY, PA, 19067, US

(21) Appl. No.: 10/771,594

(22) Filed: Feb. 4, 2004

Related U.S. Application Data
(63) Continuation-in-part of application No. 10/439,164, filed on May 16, 2003.
Application No. 10/439,164 is a continuation-in-part of application No. 10/417,598, filed on Apr. 18, 2003.

(51) Int. Cl. E05D 15/22

(52) U.S. Cl. 49/181

(57) ABSTRACT

A counterbalance system for a tilt-in window and its method of operation. Posts are provided on the sides of a tilt-in window sash that rotate when the sash is tilted. A brake structure is attached to each post within the confines of the window track. Each brake structure has a first contoured surface that rotates with the post when said sash is tilted. A second contoured surface is provided within the window track. The second contoured surface moves up and down in the track with the post but does not rotate with the post when the sash is tilted. When the window sash is tilted for cleaning, the first contoured surface moves against the second contoured surface within the window track. A cam action occurs that moves the first contoured surface away from the second contoured surface. This causes the brake structure to be biased against the track and lock in a fixed position within the track.

### RELATED APPLICATIONS

This application is a Continuation-In-Part of copending U.S. patent application Ser. No. 10/439,164, filed May 16, 2003, which was a Continuation-In-Part of copending U.S. patent application Ser. No. 10/417,598, which was filed on Apr. 18, 2003.

### BACKGROUND OF THE INVENTION

1. Field of the Invention

In general, the present invention relates to counterbalance systems for windows that prevent open window sashes from closing under the force of their own weight. More particularly, the present invention system relates to counterbalance systems for tilt-in windows that use curl springs to create a counterbalancing force.

2. Description of the Prior Art

There are many types and styles of windows. One of the most common types of window is the double-hung window. A double-hung window is the most common window found in traditional home construction. A double-hung window consists of an upper window sash and a lower window sash. Either the upper window sash or the lower window sash can be selectively opened and closed by a person sliding the sash up and down within the window frame.

A popular variation of the double-hung window is the tilt-in double-hung window. Tilt-in double-hung windows have sashes that can be selectively moved up and down. Additionally, the sashes can also be selectively tilted into the home so that the exterior of the sashes can be cleaned from within the home.

The sash of a double-hung window has a weight that depends upon the materials used to make that window sash and the size of the window sash. Since the sashes of a double-hung window are free to move up and down in the frame of a window, some counterbalancing system must be used to prevent the window sashes from always moving to the bottom of the window frame under the force of their own weight.

For many years counterbalance weights were hung next to the window frame in weight wells. The weights were attached to the window sash using a string or chain that passed over a pulley at the top of the window frame. The weights counterbalanced the weight of the window sashes. As such, when the sashes were moved in the window frame, they had a neutral weight and friction would hold them in place.

The use of weight wells, however, prevents insulation from being packed tightly around a window frame. Furthermore, the use of counterbalance weights on chains or strings cannot be adapted well to tilt-in double-hung windows. Accordingly, as tilt-in windows were being developed, alternative counterbalance systems were developed that were contained within the confines of the window frame and did not interfere with the tilt action of the tilt-in windows.

Modern tilt-in double-hung windows are primarily manufactured in one of two ways. There are vinyl frame windows and wooden frame windows. In the window manufacturing industry, different types of counterbalance systems are traditionally used for vinyl frame windows and for wooden frame windows. The present invention is mainly concerned with the structure of vinyl framed windows. As such, the prior art concerning vinyl framed windows is herein addressed.

Vinyl framed, tilt-in, double-hung windows are typically manufactured with tracks along the inside of the window frame. Brake shoe mechanisms, commonly known as “shoes” in the window industry, are placed in the tracks and ride up and down within the tracks. Each sash of the window has two tilt pins or tilt posts that extend into the shoes and cause the shoes to ride up and down in the tracks as the window sashes are opened or closed.

In prior art counterbalance systems, the shoes serve more than one purpose. The shoes contain a brake mechanism that is activated by the tilt post of the window sash when the window sash is tilted inwardly away from the window frame. The shoe therefore locks the tilt post in place and prevents the base of the sash from moving up or down in the window frame once the sash is tilted open. Second, the shoes engage curl springs. Curl springs are constant force coil springs that supply a constant retraction force when unwound. In some counterbalance systems, curl springs are placed within the shoe in the same way a metal tape is placed within the housing of a tape measure. One end of the curl spring is anchored to the frame of the window while the main body of the curl spring is wound inside of the shoe. As the shoes move within the tracks, the curl spring rotates inside the shoe. Often as the curl spring rotates inside the shoe, the curl spring moves around within the confines of the shoe and makes an undesirable noise.

Single curl springs are used on windows with light sashes. Multiple curl springs are used on windows with heavy sashes. The curl springs provide the counterbalance force to the window sashes needed to maintain the sashes in place. The counterbalance force of the curl springs is transferred to the window sashes through the structure of the shoes and the tilt posts that extend from the window sash into the shoes.

Prior art shoes that contain braking mechanisms and engage counterbalance curl springs are exemplified by U.S. Pat. No. 6,378,169 to Batten, entitled Mounting Arrangement For Constant Force Spring Balance; U.S. Pat. No. 5,463,793 to Westfall, entitled Sash Shoe System For Curl Spring Window Balance; and U.S. Pat. No. 5,353,548 to Westfall, entitled Curl Spring Shoe Based Window Balance System.

Prior art shoes for curl spring counterbalance systems are complex assemblies. The shoes must contain a brake mechanism strong enough to lock a sash in place. Furthermore, the shoes must engage at least one strong curl spring. Prior art shoes are always in contact with the tracks on the sides of the window frame. Accordingly, as wear, dirt and grime accumulate over time, it often becomes more difficult for the shoes to move up and down. The shoe of a window assembly therefore often malfunctions.

If a shoe jams or otherwise malfunctions, the shoe may not enable the tilt post of the window sash to rotate freely as the window sash is tilted inward. As a window sash is tilted inward, a large torque is experienced by the tilt post at the base of the window sash. This torque is used to activate the braking mechanism in the shoe. However, if the shoe jams, slides out of its track, or otherwise malfunctions, the shoe may not allow the tilt post of the window sash to rotate freely. Consequently, the large torque force, created by the window sash being tilted, acts upon the tilt post at the bottom of the window sash. If the tilt post is not free to rotate, the torque force often bends the tilt post or breaks the tilt post off the sash. Once the tilt post is so damaged, it must be replaced. If the tilt post causes damage to the sash, the entire window sash must be replaced.

A need therefore exists in the field of vinyl, tilt-in, double-hung windows, for a counterbalance system that eliminates the need for shoes. A need also exists in the field of vinyl, tilt-in double-hung windows for a counterbalance system that provides inexpensive, easily installed tilt posts for a window sash. As such, window assemblies can be made more reliable, less noisy, less expensive and easier to repair. These needs are met by the present invention as described and claimed below.

### SUMMARY OF THE INVENTION

The present invention is a counterbalance system for a tilt-in window and its method of operation. Posts are provided on the sides of a tilt-in window sash that rotate when the sash is tilted. A brake structure is attached to each post within the confines of the window track. Each brake structure has a first contoured surface that rotates with the post when said sash is tilted. A second contoured surface is provided within the window track. The second contoured surface moves up and down in the track with the post but does not rotate with the post when the sash is tilted. When the window sash is tilted for cleaning, the first contoured surface moves against the second contoured surface within the window track. A cam action occurs that moves the first contoured surface away from the second contoured surface. This causes the brake structure to be biased against the track and lock in a fixed position within the track.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a partially fragmented view of a window assembly in accordance with the present invention, containing an enlarged view of the counterbalance system contained therein;

FIG. 2 is a perspective, exploded view of the counterbalance system shown in FIG. 1;

FIG. 3 is a cross-sectional side view of the exploded assembly of FIG. 2;

FIG. 4 is a selectively cross-sectioned view of a counterbalance system in a window frame track, with the sash being closed;

FIG. 5 is a selectively cross-sectioned view of a counterbalance system in a window frame track, with the sash being tilted open;

FIG. 6 is a perspective view of an alternate embodiment of the spring holder component of the present invention.

### DETAILED DESCRIPTION OF THE INVENTION

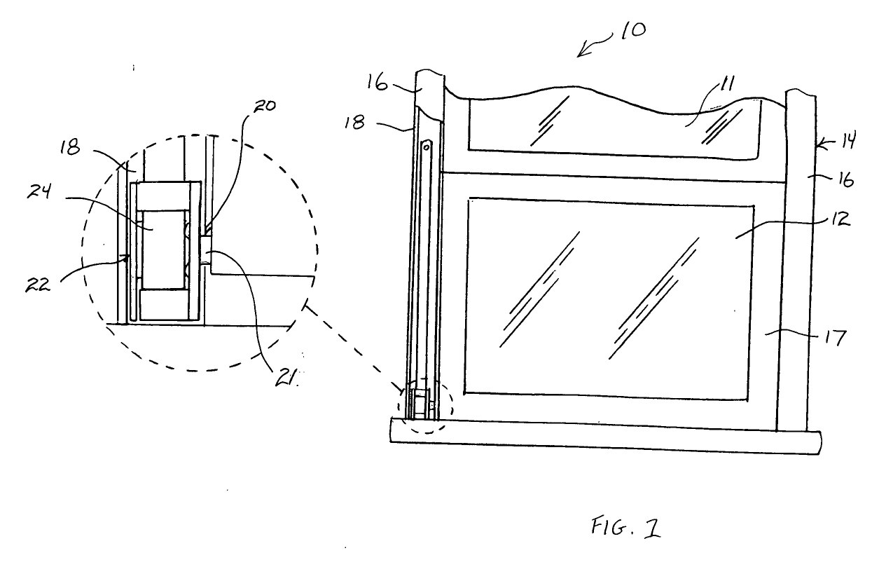

Referring to FIG. 1, there is shown an exemplary embodiment of a vinyl, tilt-in, double-hung window assembly 10. The window assembly 10 has an upper sash 11 and a lower sash 12. Each of the sashes 11, 12 has two side elements 17. The upper sash 11 and the lower sash 12 are contained within a window frame 14. The window frame 14 has two vertical sides 16 that extend along the side elements 17 of both sashes 11, 12. Within each of the vertical sides 16 of the window frame 14 is formed a track 18.

A tilt post bracket 20 is mounted to the side elements 17 of each sash 11, 12 near the bottom of each sash 11, 12. Each tilt post bracket 20 contains a horizontal post 21 that extends out away from the side of the sash 11, 12 and into the tracks 18 in the vertical sides 16 of the window frame 14. As is later explained in greater detail, a brake 22 is provided that attaches to the horizontal post 21. The brake 22 serves two purposes. First, the brake 22 serves as a brake mechanism that locks the bottom of a sash 11, 12 in place within the track 18 when a sash 11, 12 is tilted inwardly. Second, the brake 22 serves as a hub for a curl spring 24, wherein a curl spring 24 passes around the brake 22.

The curl spring 24 rotates about the brake 22. The free end of the curl spring 24 is affixed to the window frame 14 higher along the track 18. Accordingly, the curl spring 24 applies an upward counterbalance force to each sash 11, 12 that counteracts the weight of each sash 11, 12.

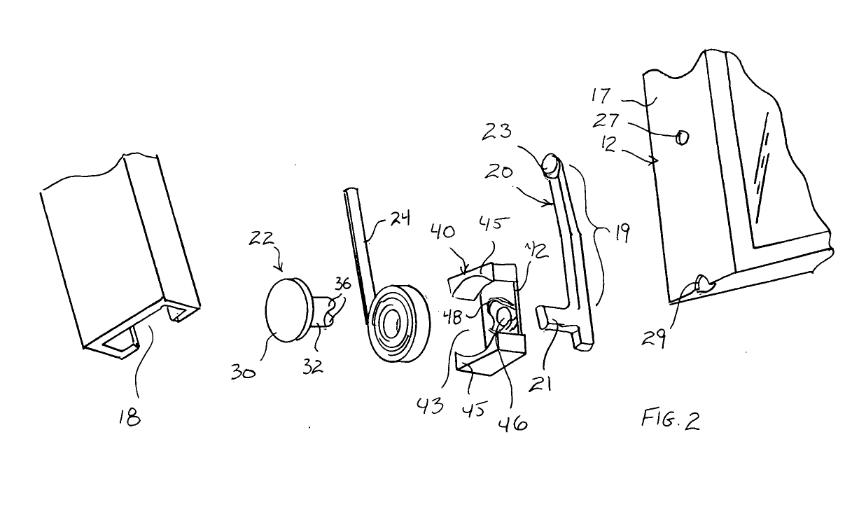

Referring to FIG. 2, it can be seen that the tilt post bracket 20 is a structure that has an elongated vertical section 19. Disposed at the top of the vertical section 19 is a locking projection 23. The locking projection 23 is used to lock the tilt post bracket 20 in place, as will later be explained.

The vertical section 19 of the tilt post bracket 20 can be mounted flush to the side element 17 of a window sash 12 or placed in a relief formed in the exterior of the side element 17. However, in a preferred embodiment, the vertical section 19 of the tilt post bracket 20 passes into the interior of the side element 17 of the sash 12, in a manner later explained. To facilitate the interconnection between the vertical section 19 of the tilt post bracket 20 and the sash 12, the side elements 17 of the sash 12 are slightly modified. As will be later shown, the interior of each side element 17 of the sash 12 is not solid. Rather, although each side element 17 of the sash 12 has a solid exterior, internally each side element 17 of the sash 12 is hollow and is reinforced with cross-ribbing. In this manner, the side elements 17 of the sash 12 can be made lighter, stronger and at a lower cost than if the side elements 17 were solid vinyl.

In the present invention, a locking hole 27 is formed in each of the side elements 17. At the base of each side element 17, a relief 29 is formed to help receive the tilt post bracket 20, as is later shown.

The horizontal post 21 extends from the bottom of the vertical section 19 of the tilt post bracket 20. The brake 22 is structured so that it passes over the end of the horizontal post 21. The interconnection between the brake 22 and the horizontal post 21 is a keyed connection that prevents the brake 22 from being rotated without the horizontal post 21 and the remainder of the tilt post bracket 20.

The brake 22 is a structure that includes an enlarged base 30 and a cylindrical hub 32 that extends laterally from one side of the enlarged base 30. The purpose and function of the enlarged base 30 is later explained.

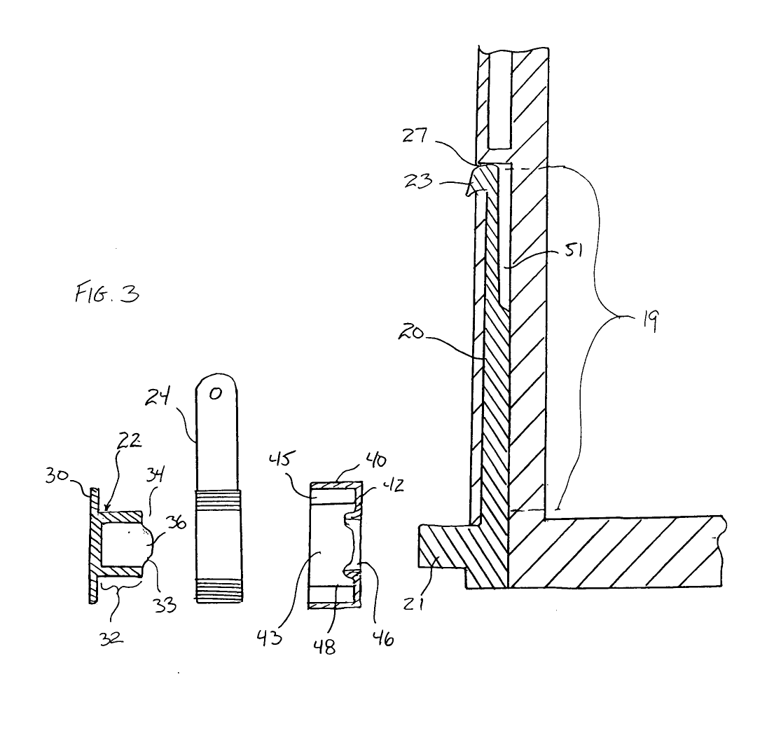

Referring to FIG. 2 in conjunction with FIG. 3, it can be seen that the cylindrical hub 32 is tubular in structure having one open end 33 at the end opposite the enlarged base 30. Thus, the cylindrical hub 32 defines an opening 34 that extends down the middle of the cylindrical hub 32. The opening 34 is shaped to receive the horizontal post 21 of the tilt post bracket 20 so that a keyed interconnection occurs and the cylindrical hub 32 is forced to rotate with the horizontal post 21.

The brake 22 defines a first contoured surface. In the shown embodiment, the open end 33 of the cylindrical hub 32 is contoured and defines at least two cam protrusions 36 that are disposed around the open end 33 in a symmetrical pattern.

A spring holder 40 is provided. The spring holder 40 has a rear wall 42. Barrier elements 45 extend forward from the rear wall 42 and define a circular opening 43 that receives the curl spring 24. An aperture 46 is formed through the rear wall 42 in a position that corresponds to the center of the circular opening 43. The aperture 46 is sized to enable the horizontal post 21 of the tilt post bracket 20 to pass through the rear wall 42. The horizontal post 21 supports the spring holder 40 in the track 18 (FIG. 2) of the window. However, the spring holder 40 is unaffected by any rotation of the horizontal post 21. As a result, the spring holder 40 can be considered a stationary structure relative to the horizontal post 21.

A cam ridge 48 is formed around the aperture 46 in the rear wall 42. The cam ridge 48 defines a second contoured surface. When assembled, the open end 33 of the cylindrical hub 32 of the brake 22 abuts against the cam ridge 48.

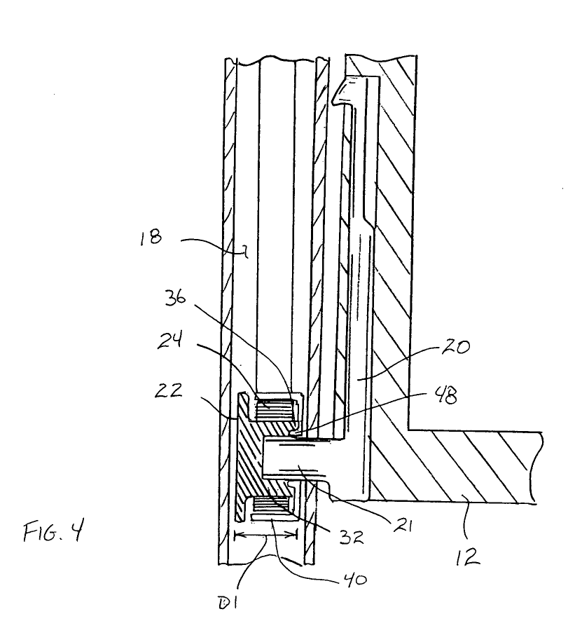

Referring to FIG. 4, it can be seen that, when assembled, the cylindrical hub 32 of the brake 22 passes over the horizontal post 21 of the tilt post bracket 20. Since both the opening in the cylindrical hub 32 and the horizontal post 21 have matching keyed shapes, the two parts interconnect in a manner that causes the brake 22 to rotate with any rotation of the horizontal post 21.

Before the brake 22 is advanced onto the horizontal post 21, the horizontal post 21 is advanced through the spring holder 40 and the curl spring 24 is placed around the cylindrical hub 32 of the brake 22. Thus, when the full assembly is placed within the track 18 of a tilt-in window, the brake 22, curl spring 24 and spring holder 40 interconnect with the horizontal post 21 of the tilt post bracket 20 and move up and down in the track 18 as the window sash 12 holding the tilt post bracket 20 is opened and closed.

When the window sash 12 is operating in the window, the window sash 12 is held in a vertical plane. When the window sash 12 is in the vertical plane, the vertical section of the tilt post bracket 20 is also held in the vertical. In such an orientation, the horizontal post 21 of the tilt post bracket 20 orients the brake 22 so that the cam protrusions 36 at the end of the cylindrical hub 32 intermesh with the contoured surface of the cam ridge 48 on the spring holder 40. Since the cam protrusions 36 on the cylindrical hub 32 intermesh with the contours of the cam ridge 48, the cam protrusions 36 lay in flush abutment with the cam ridge 48. The distance D1 between the brake 22 and the rear wall of the spring holder 40 is therefore at a minimum. This distance D1 is designed to be smaller than the width of the interior of the window track 18. As a result, the brake 22, spring holder 40 and curl spring 24 are free to move up and down within the track 18 without interference.

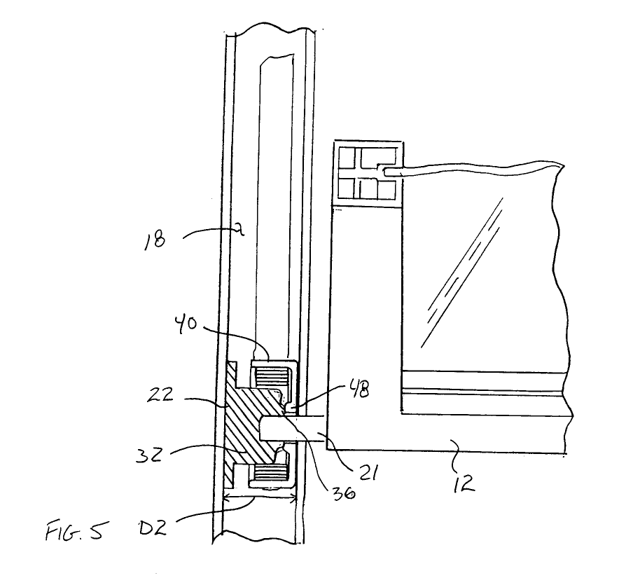

Referring to FIG. 5, it will be understood that when the sash 12 of the window is tilted inwardly out of the vertical plane, the rotation of the window sash 12 causes the horizontal post 21 to rotate. As the horizontal post 21 rotates, it causes the brake 22 to rotate. Although the brake 22 and the horizontal post 21 are rotating together, the spring holder 40 does not rotate. Due to the shape of the exterior of the spring holder 40, the spring holder 40 is prevented from rotating by the confines of the window track 18. Thus, the brake 22 rotates with the tilting of the window sash 12, but the spring holder 40 remains in the same position as a stationary structure.

As the brake 22 rotates, the cam protrusions 36 at the end of the cylindrical hub 32 move across the contours of the cam ridge 48 inside the spring holder 40. This causes the cam protrusions 36 and the contours of the cam ridge 48 to move out of alignment so that the peaks and troughs of the opposing contoured surfaces no longer intermesh. The result is that gaps are created between the cam protrusions 36 and the contours of the cam ridge 48. Due to the lack of alignment, the cylindrical hub 32 of the brake 22 is forced to rise in position relative the cam ridge 48. This causes the distance D2 between the brake 22 and the spring holder 40 to expand. This expanded distance D2 is larger than the width of the window track 18. As such, the brake 22 and the rear of the spring holder 40 are biased against the side walls of the window track 18. The result is an interference fit that causes the brake 22 and the spring holder 40 to lock into place within the window track 18. Once the brake 22 and spring holder 40 lock into place in the window track 18, the horizontal post 21 is locked in place relative the window track 18. Thus, the window sash 12 is prevented from moving either up or down in the window track 18.

Once the window sash 12 is returned to a vertical position, the horizontal post 21 rotates and the brake 22 again rotates. The cam protrusions 36 again intermesh with the contours of the cam ridge 48 and the assembly returns to the configuration of FIG. 4. Thus, the distance between the enlarged base of the brake and the rear wall of the spring holder contracts to a size smaller than the window track 18 and the assembly is again free to move up and down within the window track 18.

Referring back now to FIG. 3, it will be understood that the tilt post bracket 20 can be attached to the window sash 12 in many different ways. Traditional ways can be used, such as mounting the tilt post bracket 20 to the window sash with screws. However, in the illustrated embodiment, a novel mounting system is shown. The vertical section 19 of the tilt post bracket 20 has a complex shape. The vertical section 19 has a locking projection 23 at its top end. The structure of the vertical section 19 under the locking projection 23 is also varied. The purpose of the varied shape is to cause the vertical section 19 of the tilt post bracket 20 to conform to the internal shape of a void formed in the window sash 12.

From FIG. 3, it can be seen that within the sash 12 are voids. The voids are molded into the vinyl structure of the sash's sides to reduce weight, reduce cost, reduce expense and increase strength. The vertical section 19 of the tilt post bracket 20 extends into a void 51 in the side of the sash 12. The vertical section 19 of the tilt post bracket 20 is sized to be the same size as the void 51, so as to fill the void 51 and create maximum surface-to-surface contact between the vertical section 19 and the defining surfaces of the void 51.

The vertical section 19 of the tilt post bracket 20 thins near the locking projection 23. As such, the vertical section 19 of the tilt post bracket 20 is slightly flexible in this thinned area. Accordingly, as the vertical section 19 of the tilt post bracket 20 passes into the void 51 in the sash's side, the vertical section 19 below the locking projection 23 will deform slightly until the locking projection 23 reaches the locking hole 27. Once at the locking hole 27, the locking projection 23 pops into the locking hole 27 and the vertical section 19 is no longer slightly deformed. Accordingly, the passing of the locking projection 23 into the locking hole 27 mechanically locks the tilt post bracket 20 into the side of the sash 12.

Back in FIG. 2, a relief 29 was shown at the bottom of the side element 17 of the sash 12. In FIG. 3, it will be understood that the relief 29 (shown only in FIG. 2) allows the tilt post bracket 20 to pass into side of the sash 12 so as not to protrude too far below the bottom of the sash 12.

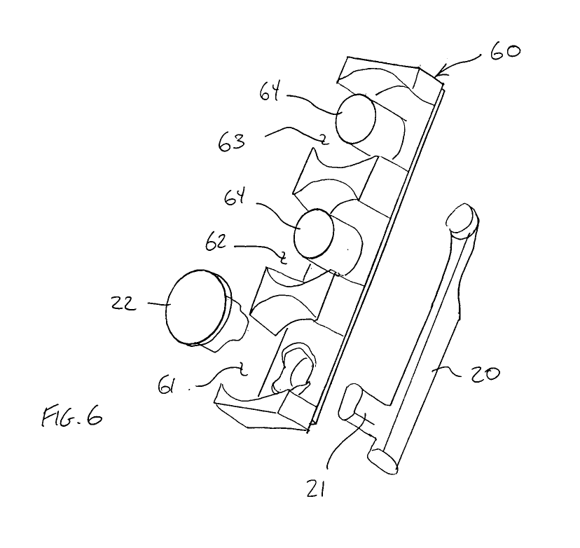

Referring to FIG. 6, an alternate embodiment of the spring holder 60 is shown in conjunction with a brake 22 and a tilt post bracket 20 of the type previously described. In this embodiment, the spring holder 60 is elongated and divided into multiple compartments 61, 62, 63 capable of holding curl springs. The first compartment 61 has the structure previously described. The horizontal post 21 of the tilt post bracket 20 extends into this first compartment 61 and engages the brake 22 within this first compartment 61. The subsequent compartments 62, 63 all have spool posts 64 for receiving and holding other curl springs. In the shown embodiment, the spring holder 60 can hold three curl springs. However, it should be understood that the spring holder 60 can be configured to hold any plurality of curl springs.

It will be understood that the embodiments of the present invention counterbalance system that are described and illustrated herein are merely exemplary and a person skilled in the art can make many variations to the embodiment shown without departing from the scope of the present invention. All such variations, modifications and alternate embodiments are intended to be included within the scope of the present invention as defined by the appended claims.

What is claimed is:

1. In a tilt-in window assembly having a sash and tracks that extend along opposite sides of the sash, wherein the sash is selectively positionable between a non-tilted position and a tilted position, a counterbalance system for the sash, comprising:
a post extending horizontally into said tracks from opposite sides of the sash, wherein each said post rotates with said sash when said sash is moved between said tilted position and said non-titled position;
a brake structure coupled to each said post within said tracks, said brake structure having a first contoured surface thereon, wherein said brake structure and said first contoured surface rotate with said post as said sash is moved between said tilted position and said non-tilted position;
a second contoured surface supported by said post within said track, wherein said second contoured surface contacts said first contoured surface, and wherein said first contoured surface and said second contoured surface fully intermesh when said sash is in said non-tilted position and do not fully intermesh when said sash is in said tilted position.

2. The system according to claim 1 wherein said brake structure abuts against said track when said first contoured surface is not fully intermeshed with said second contoured surface, therein locking said brake structure in place within said track.

3. The system according to claim 1 wherein said brake structure does not contact said track when said first contoured surface and said second contoured surface are intermeshed.

4. The system according to claim 1, wherein said brake structure includes a cylindrical hub that terminates at one end with said first contoured surface.

5. The system according to claim 4, further including a curl spring, wherein said curl spring is disposed around said cylindrical hub.

6. The system according to claim 1, further including at least one curl spring and a spring holder for holding said at least one curl spring, wherein said second contoured surface is disposed on said spring holder.

7. In a tilt-in window assembly having a sash and tracks that extend along opposite sides of the sash, wherein the sash is selectively positionable between a non-tilted position and a tilted position, a counterbalance system for the sash, comprising:
a post extending into said tracks from opposite sides of the sash, wherein each said post rotates with said sash when said sash is moved between said tilted position and said non-titled position;
a stationary structure supported by said post, wherein said stationary structure moves in said track with said post but does not rotate with said post when said sash is moved between said titled position and said non-tilted position;
a brake structure coupled to each said post within said tracks, said brake structure having a first contoured surface thereon that rotates with said post as said sash is moved between said tilted position and said non-tilted position;
wherein said first contoured surface moves against said stationary structure when said sash is moved between said non-tilted position and said tilted position, causing said brake surface to be biased against said track when said sash is in said titled position.

8. The system according to claim 7, wherein said stationary structure is biased against said track when said sash is in said tilted position.

9. The system according to claim 7, wherein said stationary structure has a second contoured surface that contacts said first contoured surface of said brake structure.

10. The system according to claim 9, wherein said first contoured surface and said second contoured surface intermesh when said sash is in the non-tilted position and do not intermesh when said sash is in said tilted position.

11. The system according to claim 7, wherein said brake structure includes a cylindrical hub that terminates at one end with said first contoured surface.

12. The system according to claim 7, further including a curl spring, wherein said curl spring is disposed around said cylindrical hub.

13. The system according to claim 7, further including at least one curl spring and said stationary structure is a spring holder that retains said at least one curl spring.

14. A method of locking the sash of a tilt-in window in place in a window track, comprising the steps of:
providing a post on both sides of the sash that extend into the window track and rotate when the sash is tilted;
attaching a brake structure to each post within the window track, wherein each brake structure has a first surface that rotates with said post when said sash is tilted;
providing a second surface within said track that does not rotate with said horizontal post when said sash is tilted;
wherein said first surface moves against said second surface when said sash is titled inwardly causing said brake structure to be biased against said track.

15. The method according to claim 14, wherein said step of attaching a brake structure to each horizontal post includes providing a brake structure with a cylindrical section and sliding said cylindrical section over said post.

16. The method according to claim 15 further including the step of providing a curl spring having an open center region and passing said cylindrical section of said brake structure through said open center region so that said brake structure supports said curl spring.

17. The method according to claim 14, wherein said step of providing a second surface within said track includes providing a spring holder, wherein said second surface is disposed on said spring holder.

18. The method according to claim 17, further including the step of providing at least one curl spring and positioning said at least one curl spring within said spring holder.
